(19) United States
(12) Patent Application Publication
(10) Pub. No.: US 2014/0302983 A1
(43) Pub. Date: Oct. 9, 2014

(54) System and Method for Two and Three Way NB-ZR Catalyst

(71) Applicant: Zahra Nazarpoor, Camarillo, CA (US)

(72) Inventor: Zahra Nazarpoor, Camarillo, CA (US)

(73) Assignee: CDTi, Ventura, CA (US)

(21) Appl. No.: 13/856,859

(22) Filed: Apr. 4, 2013

(51) Int. Cl. B01J 23/20

(52) U.S. Cl. CPC B01J 23/20
USPC 502/304

(57) ABSTRACT

Disclosed here are material formulations of use in the conversion of exhaust gases, where the formulations may include Niobium (Nb), Zirconium (Zr) and combinations thereof.

### CROSS-REFERENCE TO RELATED APPLICATIONS

N/A

### BACKGROUND

1. Technical Field

This disclosure relates generally to catalytic converters, and, more particularly, to materials of use in catalyst systems.

2. Background Information

Emissions standards seek the reduction of a variety of materials in exhaust gases, including unburned hydrocarbons (HC), carbon monoxide (CO), and nitrogen oxides (NO). In order to meet such standards, catalyst systems able to convert such materials present in the exhaust of any number of mechanisms are needed.

To this end, there is a continuing need to provide materials able to perform in a variety of environments, which may vary in a number ways, including oxygen content and the temperature of the gases undergoing treatment.

### SUMMARY

Materials suitable for use as catalyst include Niobium (Nb), Zirconium (Zr), and combinations thereof. Methods for preparing catalysts containing these materials may use Niobium Oxalate and/or Niobium Pentoxide as a niobium source.

Support materials of use in catalysts containing one or more of the aforementioned combinations may include Cerium Oxide, Alumina, Lanthanum doped alumina,Titanium Oxide, Zirconia, and Ceria/Zirconia (CZO).

Numerous other aspects, features and advantages of the present disclosure may be made apparent from the following detailed description, taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the invention. In the figures, any reference numerals designate corresponding parts throughout different views.

FIG. 1 is an XRD Graph for a Type 1 Catalyst

FIG. 2 is an XRD Graph for a Type 2 Catalyst

FIG. 3 is an XRD Graph comparing a Type 1 and a Type 3 Catalyst

FIG. 4 shows a Structure Comparison

FIG. 5 shows a Lean/Rich Condition HC Conversion Comparison Graph

FIG. 6 shows a HC Conversion Comparison Graph for Type 1 Catalysts with varying CMOs

FIG. 7 shows a HC Conversion Graph comparing a Type 1 Catalyst with and without Sn doping.

### DETAILED DESCRIPTION

Disclosed here are catalyst materials that may be of use in the conversion of exhaust gases, according to an embodiment.

The present disclosure is here described in detail with reference to embodiments illustrated in the drawings, which form a part hereof. In the drawings, which are not necessarily to scale or to proportion, similar symbols typically identify similar components, unless context dictates otherwise. Other embodiments may be used and/or other changes may be made without departing from the spirit or scope of the present disclosure. The illustrative embodiments described in the detailed description are not meant to be limiting of the subject matter presented herein.

### Definitions

As used here, the following terms have the following definitions:

“Exhaust” refers to the discharge of gases, vapor, and fumes that may include hydrocarbons, nitrogen oxide, and/or carbon monoxide.

“R Value” refers to the number obtained by dividing the reducing potential by the oxidizing potential.

“Rich Exhaust” refers to exhaust with an R value above 1.

“Lean Exhaust” refers to exhaust with an R value below 1.

“Conversion” refers to the chemical alteration of at least one material into one or more other materials.

“Catalyst” refers to one or more materials that may be of use in the conversion of one or more other materials.

“Carrier Material Oxide (CMO)” refers to support materials used for providing a surface for at least one catalyst.

“Oxygen Storage Material (OSM)” refers to a material able to take up oxygen from oxygen rich streams and able to release oxygen to oxygen deficient streams.

“Three Way Catalyst (TWC)” refers to a catalyst suitable for use in converting at least hydrocarbons, nitrogen oxide, and carbon monoxide.

“Oxidation Catalyst” refers to a catalyst suitable for use in converting at least hydrocarbons and carbon monoxide.

“Wash-coat” refers to at least one coating including at least one oxide solid that may be deposited on a substrate.

“Over-coat” refers to at least one coating that may be deposited on at least one wash-coat or impregnation layer.

“Zero Platinum Group (ZPGM) Catalyst” refers to a catalyst completely or substantially free of platinum group metals.

“Platinum Group Metals (PGMs)” refers to platinum, palladium, ruthenium, iridium, osmium, and rhodium.

### DESCRIPTION OF THE DRAWINGS

A catalyst in conjunction with a sufficiently lean exhaust (containing excess oxygen) may result in the oxidation of residual HC and CO to small amounts of carbon dioxide (CO2) and water (H20), where equations (1) and (2) take place.

2CO+O2→2CO2 (1)

2CₘHₙ+(2m+½n)O₂→2mCO₂+nH2O (2)

Although dissociation of NO into its elements may be thermodynamically favored, under practical lean conditions this may not occur. Active surfaces for NO dissociation include metallic surfaces, and dissociative adsorption of NO, equation (3), may be followed by a rapid desorption of N2, equation (4). However, oxygen atoms may remain strongly adsorbed on the catalyst surface, and soon coverage by oxygen may be complete, which may prevent further adsorption of NO, thus halting its dissociation. Effectively, the oxygen atoms under the prevailing conditions may be removed through a reaction with a reductant, for example with hydrogen, as illustrated in equation (5), or with CO as in equation (6), to provide an active surface for further NO dissociation.

2NO→2N_{ads}+20ads (3)

N_{ads}+N_{ads}→N2 (4)

Oads+H₂→H2O (5)

Oads+CO→CO2 (6)

Materials that may allow one or more of these conversions to take place may include ZPGM catalysts, including catalysts containing Niobium(Nb), Zirconium(Zr) and combinations thereof. Catalysts containing the aforementioned metals may include any suitable Carrier Material Oxides, including Cerium Oxides, Aluminum Oxides, Titanium Oxides, doped aluminum oxide, doped ceria, fluorite, zirconium oxide, doped zirconia, titanium oxide, tin oxide, silicon dioxide, zeolite, and combinations thereof. ZPGM Catalyst may include any number of suitable OSMs, including cerium oxide, zirconium oxide, lanthanum oxide, yttrium oxide, lanthanide oxides, actinide oxides, and combinations thereof. Catalysts containing the aforementioned metals, Carrier Material Oxides, and/or Oxygen Storage Materials may be suitable for use in conjunction with catalysts containing PGMs. Catalysts with the aforementioned qualities may be used in a washcoat or overcoat, in ways similar to those described in US 20100240525.

Catalysts containing Nb and Zr may promote the chemisorption of C3H6 by an acidic attack on the hydrocarbon double bond, as in equation (7)

CH₂═CH—CH₃+H⁺→(CH3-CH—CH3)⁺ (7)

Catalysts containing Nb and Zr may exhibit resistance to SO2 poisoning, may display enhanced oxidative properties, may display high permanent Brønsted acidity, may exhibit higher thermal stability, and/or may promote the formation of reaction intermediates at temperatures below 150° C.

Catalyst Preparation

Catalysts similar to those described above may be prepared by co-precipitation. Co-precipitation may include the preparation of a suitable metal salt solution, where precipitate may be formed by the addition of a suitable base, including but not limited to Tetraethyl Ammonium Hydrate, NH₄OH, (NH₄)₂CO₃, other tetraalkylammonium salts, ammonium acetate, and ammonium citrate. This precipitate may be formed over a slurry including at least one suitable carrier material oxide, where the slurry may include any number of additional suitable Carrier Material Oxides, and may include one or more suitable Oxygen Storage Materials. The slurry may then undergo filtering and may undergo washing, where the resulting material may be dried and may later be fired. The resulting catalyst may then be subjected to an aging process.

Metal salt solutions suitable for use in the co-precipitation process described above may include solutions of Niobium Pentoxide (Nb₂O₅) and Niobium Oxalate (NbC₂O₄) in any suitable solvent, including but not limited to Sulfuric Acid (H2SO4).

The catalyst may also be formed on a substrate, where the substrate may be of any suitable material, including cordierite. The washcoat may include one or more carrier material oxides and may also include one or more OSMs. Nb, Zr, and combinations thereof may be precipitated on said one or more carrier material oxides or combination of carrier material oxide and oxygen storage material, where the catalyst may be synthesized by any suitable chemical technique, including solid-state synthesis and co-precipitation. The milled catalyst and carrier material oxide may then be deposited on a substrate, forming a washcoat, where the washcoat may undergo one or more heat treatments.

XRD Analysis

Catalysts containing Nb and Zr include: Type 1 Catalysts, prepared from a NbC₂O₄ precursor and having a ZrO₂:Nb2O5 molar ratio of about 6:1; Type 2 Catalysts, prepared from a Nb₂O₅ precursor and having a ZrO₂:Nb2O5 molar ratio of about 6:1; Type 3 Catalysts, prepared from a NbC₂O₄ precursor and having a ZrO₂:Nb2O5 molar ratio of about 1:6.

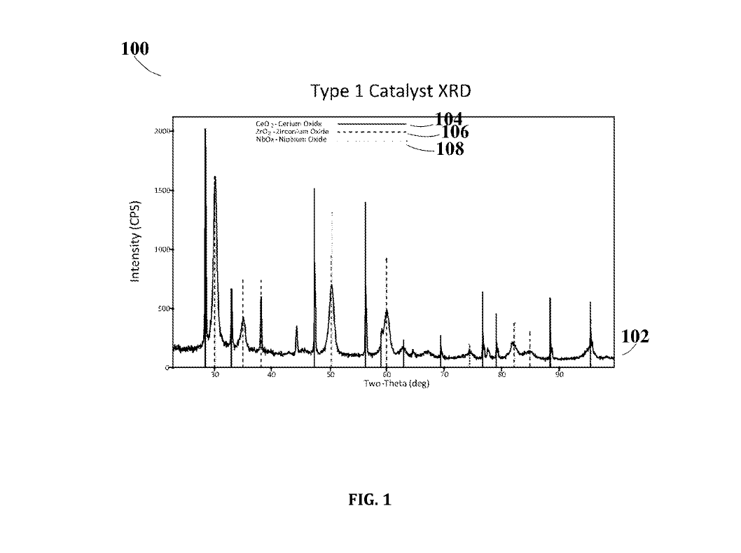

FIG. 1 shows XRD Graph 100 for Type 1 Catalyst 102. XRD Graph 100 indicates the presence of Cerium Oxide 104, Zirconium Oxide 106, and Niobium Oxide 108. It may be seen from XRD Graph 100 that Type 1 Catalyst 102 forms a Mixed Metal Oxide Phase including Zr, Nb, and Ce oxide.

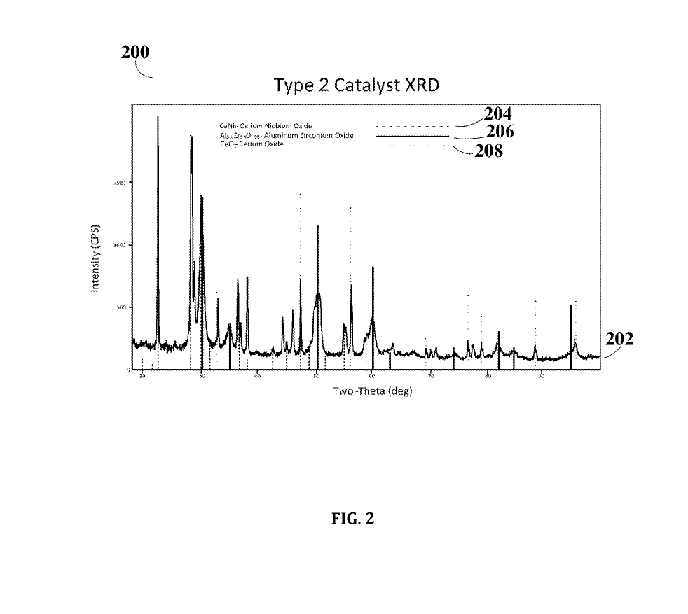

FIG. 2 shows XRD Graph 200 for Type 2 Catalyst 202. XRD Graph 200 indicates the presence of Cerium Niobium Oxide 204, Aluminum Zirconium Oxide 206, and Cerium Oxide 208. It may be seen from XRD Graph 200 that Type 2 Catalyst 202 forms a Mixed Solid Solution Phase including Ce—Nb Oxide and Al—Zr.

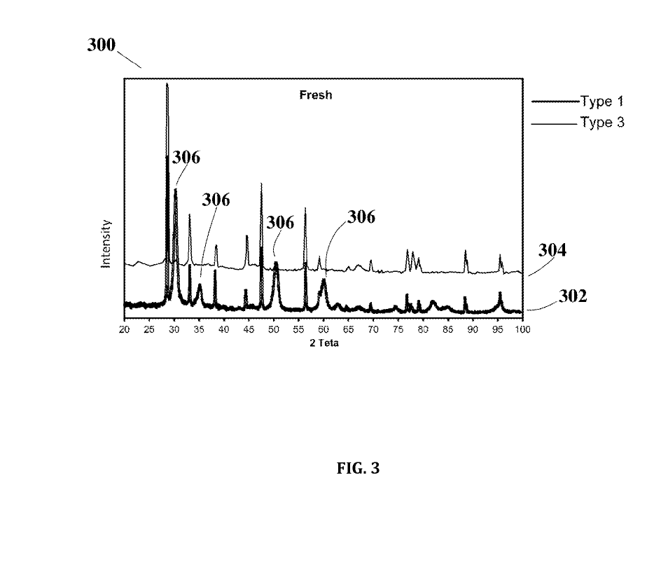

FIG. 3 shows XRD Graph 300 for Type 1 Catalyst 302 and Type 3 Catalyst 304. In XRD Graph 300, Type 3 Catalyst 304 may show a reduction of the intensity of ZrO2 Peaks 306 compared to Type 1 Catalyst 302, though both show a formation of mixed metal oxide phases including Nb Oxide, Ce Oxide, and Zr Oxide.

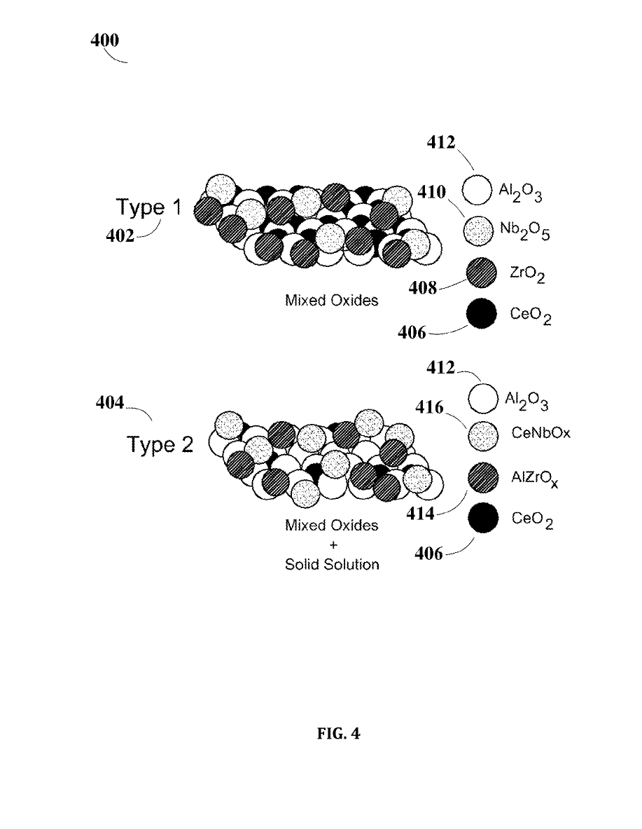

FIG. 4 shows Structure Comparison 400, with Type 1 Catalyst Structure 402 and Type 2 Catalyst Structure 404. Type 1 Catalyst Structure 402 includes CeO2 406, Nb2O5 408, ZrO2 410, and Al2O3 412. Type 2 Catalyst Structure 404 includes CeO2 406, Al2O3 412, AlZrOx 414 and CeNbOx 416. Note that Type 1 Catalyst Structure 402 is a mixed oxide structure which includes mixed metal oxide phases, including CeO2 406, Nb2O5 408, ZrO2 410, and Al3O3 412. Type 2 Catalyst Structure 404 includes mixed metal oxide phases and solid solution phases, including: Al—Zr oxide and Nb—Ce oxide as a solid solutions; and Al2O3 and CeO2 as metal oxide phases.

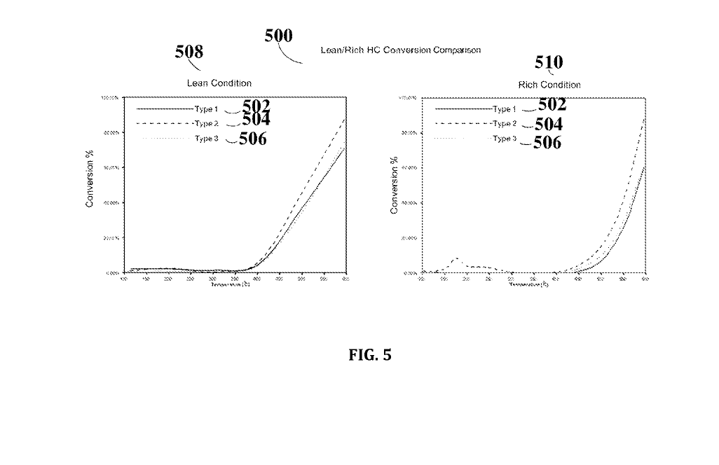

FIG. 5 shows HC Conversion Graphs 500 for Type 1 Catalyst 502, Type 2 Catalyst 504, and Type 3 Catalyst 506 in both Lean Condition Graph 508 and Rich Condition Graph 510. Type 2 Catalyst 504 seems to have a higher HC conversion rate than Type 1 Catalyst 502 and Type 3 Catalyst 506 at temperatures of about 400° C. and greater in both Lean Condition Graph 508 and Rich Condition Graph 510. Type 1 Catalyst 502 and Type 3 Catalyst 506 seem to behave similarly throughout the tested temperature range in Lean Condition Graph 508, though Type 3 Catalyst 506 seems to show a relatively higher conversion rate than Type 1 Catalyst 502 in the 420° C. to 570° C. range.

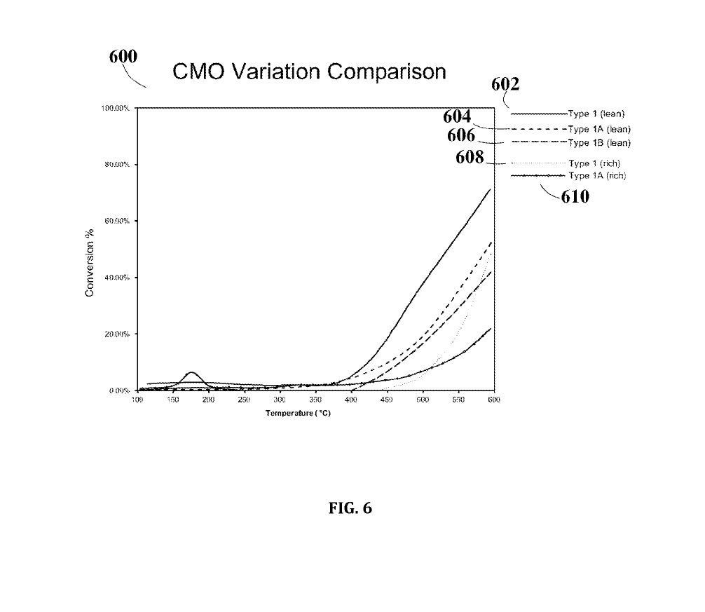

FIG. 6 shows HC Conversion Graph 600 for Type 1 catalysts with varying Carrier Material Oxides, including curves for Type 1 (lean) 602, Type 1A (lean) 604, Type 1B (lean) 606, Type 1 (rich) 608 and Type 1A (rich) 610. Type 1 (lean) 602 and Type 1 (rich) 608 show the behavior of a Type 1 catalyst, made using a combination of lanthanum doped Alumina and Ceria as the CMO, under lean and rich condition, respectively. Type 1A (lean) 604 and Type 1A (rich) 610 show the behavior of a Type 1 catalyst, made using ZrO₂ as the CMO, under lean and rich condition, respectively. Type 1B (lean) 606 shows the behavior of a Type 1 catalyst, made using lanthanum doped alumina as the CMO, under lean condition. HC Conversion Graph 600 shows Type 1 (lean) 602 having a higher conversion rate than Type 1A (lean) 604 and Type 1B (lean) 606 at temperatures above about 370° C.

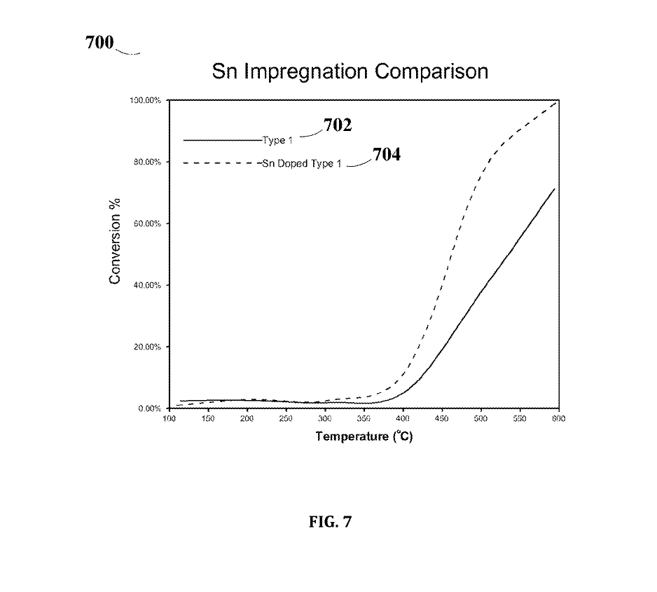

FIG. 7 shows HC Conversion Graph 700 for Type 1 Catalyst 702 and Sn Doped Type 1 Catalyst 704. Both Type 1 Catalyst 702 and Sn Doped Type 1 Catalyst 704 use a combination of lanthanum doped alumina and CeO2 as the carrier material oxide, and Sn Doped Type 1 Catalyst 704 seems to have a higher conversion rate than Type 1 Catalyst 702 above 200° C. within the temperature range tested.

### EXAMPLES

### Example 1

A Type 1 Catalyst is prepared from a Niobium Oxalate source such that the niobium content in the catalyst is 10-20 wt %, the ZrO₂:NbO₅ molar ratio is of about 6:1, and the Alumina:Ceria ratio is of about 60:40. The catalyst is prepared through co-precipitation using suitable base such as Tetraethyl Ammonium Hydrate, NH4OH, (NH4)2CO3, other tetraalkylammonium salts, ammonium acetate, or ammonium citrate. The pH was adjusted at neutral condition. The resulting precipitae cake was filtered, washed several times and dried overnight at 120° C. The powder was then grinded and fired at 700° C. for 4 hours. The resulting catalyst is found to have a BET surface area of 70.3 m²/g and has a behavior similar to Type 1 Catalyst 502.

### Example 2

A Type 2 Catalyst is prepared from a Niobium Pentoxide source such that the niobium content in the catalyst is 10-20 wt %, the ZrO₂:NbO₅ molar ratio is of about 6:1, and the Alumina:Ceria ratio is of about 60:40. The catalyst is prepared through co-precipitation using suitable base such as Tetraethyl Ammonium Hydrate, NH4OH, (NH4)2CO3, other tetraalkylammonium salts, ammonium acetate, or ammonium citrate. The pH was adjusted at neutral condition. The resulting precipitae cake was filtered, washed several times and dried overnight at 120° C. The powder was then grinded and fired at 700° C. for 4 hours. The resulting catalyst is found to have a BET surface area of 56.1 m²/g and has a behavior similar to Type 2 Catalyst 504.

### Example 3

A Type 3 Catalyst is prepared from a Niobium Oxalate source such that the niobium content in the catalyst is 10-20 wt %, the ZrO₂:NbO₅ molar ratio is of about 1:6, and the Alumina:Ceria ratio is of about 60:40. The catalyst is prepared through co-precipitation using suitable base such as Tetraethyl Ammonium Hydrate, NH4OH, (NH4)2CO3, other tetraalkylammonium salts, ammonium acetate, or ammonium citrate. The pH was adjusted at neutral condition. The resulting precipitae cake was filtered, washed several times and dried overnight at 120° C. The powder was then grinded and fired at 700° C. for 4 hours. The resulting catalyst is found to have a BET surface area of 62.9 m²/g and has a behavior similar to Type 3 Catalyst 506.

I claim:

1. A method for reducing emissions from an engine having associated therewith an exhaust system, the method providing a catalyst system for a catalytic reaction, the method further comprising the steps of:
providing a substrate; and
depositing on said substrate a washcoat suitable for deposition on the substrate and comprising at least one carrier material oxide, at least one catalyst, or mixtures thereof;
wherein the at least one catalyst comprises at least one material selected from the group consisting of niobium, zirconium, tin, and mixtures thereof.

2. The method of claim 1, wherein the at least one carrier material oxide is selected from the group consisting of cerium oxide, alumina, lanthanum doped alumina, titanium oxide, zirconia, and ceria/zirconia.

3. The method of claim 1, wherein the tin is deposited by impregnation.

4. The method of claim 1, wherein a T50 conversion temperature for hydrocarbons is less than about 500 degrees Celsius.

5. The method of claim 1, wherein the at least one catalyst is prepared by co-precipitation utilizing at least one material selected from the group consisting of niobium pentoxide, niobium oxalate, or mixtures thereof.

6. The method of claim 5, wherein the preparation further comprises sulfuric acid acting as a solvent.

7. The method of claim 1, wherein the washcoat further comprises at least one oxygen storage material.

8. The method of claim 7, wherein the oxygen storage material is selected from the group consisting of at least one of cerium, zirconium, neodymium, praseodymium, samarium, lanthanum, and yttrium.

9. The method of claim 7, wherein the at least one catalyst is precipitated on said at least at least one oxygen storage material.

10. The method of claim 1, wherein the at least one catalyst is precipitated on the at least one carrier material oxide.

11. A method for reducing emissions from an engine having associated therewith an exhaust system, the method providing a catalyst system effective for providing a catalytic reaction, the method further comprising the steps of:
providing a substrate; and
depositing on said substrate a washcoat suitable for deposition on the substrate and comprising at least one carrier material oxide, at least one catalyst, or mixtures thereof;
wherein the at least one catalyst comprises at least one material selected from the group consisting of niobium oxide, zirconium oxide, cerium oxide, cerium-niobium oxide, and aluminum zirconium oxide, and mixtures thereof.

12. The method of claim 11, wherein the at least one carrier material oxide is selected from the group consisting of cerium oxide, alumina, lanthanum doped alumina, titanium oxide, zirconia, and ceria/zirconia.

13. The method of claim 11, wherein the at least one catalyst further comprises at least one oxide selected from the group consisting of tin oxide, and tin dioxide, and mixtures thereof

14. The method of claim 13, wherein the at least one oxide is deposited by impregnation.

15. The method of claim 11, wherein a T50 conversion temperature for hydrocarbons is less than about 500 degrees Celsius.

16. The method of claim 11, wherein the catalyst is prepared by co-precipitation utilizing at least one material selected from the group consisting of niobium pentoxide, and niobium oxalate, or mixtures thereof.

17. The method of claim 16, wherein the preparation further utilizes sulfuric acid as a solvent.

18. The method of claim 11, wherein the washcoat further comprises at least one oxygen storage material.

19. The method of claim 18, wherein the oxygen storage material is selected from the group consisting of at least one of cerium, zirconium, neodymium, praseodymium, samarium, lanthanum, and yttrium.

20. The method of claim 18, wherein the at least one catalyst is precipitated on the at least at least one oxygen storage material.

21. The method of claim 11, wherein the at least one catalyst is precipitated on the at least one carrier material oxide.
